(19) United States
(12) Patent Application Publication
(10) Pub. No.: US 2025/0355291 A1
(43) Pub. Date: Nov. 20, 2025

(54) OPTICAL MODULATION VIA BRILLOUIN SCATTERING IN A SOLIDLY MOUNTED WAVEGUIDE

(71) Applicant: QUALCOMM Incorporated, San Diego, CA (US)

(72) Inventor: Willi AIGNER, Moosinning (DE)

(21) Appl. No.: 18/781,769

(22) Filed: Jul. 23, 2024

Related U.S. Application Data
(60) Provisional application No. 63/648,055, filed on May 15, 2024.

(51) Int. Cl. G02F 1/125; G02F 1/35; G02F 1/365

(52) U.S. Cl. CPC G02F 1/125; G02F 1/353; G02F 1/365; G02F 2201/124; G02F 2201/346

(57) ABSTRACT

Systems, devices, and techniques are described herein solidly mounted acousto-optical devices. One aspect includes a piezoelectric layer comprising a top surface and a bottom surface, waveguide on the top surface of the piezoelectric layer, a first interdigital transducer disposed on the top surface of the piezoelectric layer, wherein the first interdigital transducer is positioned on a first side of the waveguide, and a second interdigital transducer disposed on the top surface of the piezoelectric layer, wherein the second interdigital transducer is positioned on a second side of the waveguide opposite the first side.

### CROSS-REFERENCE TO RELATED APPLICATIONS

The present patent application claims the priority benefit of U.S. Provisional Patent Application 63/648,055, filed May 15, 2024, the disclosures of which is incorporated herein by reference in its entirety and for all purposes.

### TECHNICAL FIELD

The present disclosure relates generally to electronics and integrated photonics. For example, aspects of the present disclosure relate to the structure and use of acousto-optical devices (e.g., modulators) using Brillouin scattering with a silicon waveguide.

### BACKGROUND

Demands on communication systems and technologies are requiring ever more throughput with small form factor demands and cost pressures. Optical communications, particularly using optical waveguides, provide resistance to electromagnetic interference and lower attenuation over distance when compared with standard wired or wireless electrical or electromagnetic signals. Existing technologies to manage optical signals, however, are often significantly more complex and expensive than electrical and wireless technologies.

### BRIEF DESCRIPTION OF THE DRAWINGS

Illustrative examples of the present application are described in detail below with reference to the following figures:

FIG. 1A is a diagram illustrating aspects of an electroacoustic resonator (e.g., interdigital transducer) for use with a device in accordance with aspects described herein;

FIG. 1B is a diagram illustrating aspects of an electroacoustic resonator (e.g., interdigital transducer) for use with a device in accordance with aspects described herein;

FIG. 2A is cross section perspective of aspects of a device in accordance with aspects described herein;

FIG. 2B is cross section perspective of aspects of a device in accordance with aspects described herein;

FIG. 2C is an isometric view of one implementation of a device in accordance with aspects described herein;

FIG. 2D is a graph illustrating aspects of modulation via Brillouin scattering in accordance with aspects described herein;

FIG. 2E is a graph illustrating aspects of modulation via Brillouin scattering in accordance with aspects described herein;

FIG. 3 is cross section perspective of aspects of a solidly mounted device in accordance with aspects described herein;

FIG. 4A is cross section perspective illustrating a structure associated with an intermediate fabrication step for aspects of a device in accordance with aspects described herein;

FIG. 4B is cross section perspective illustrating a structure associated with an intermediate fabrication step for aspects of a device in accordance with aspects described herein;

FIG. 4C is cross section perspective illustrating a structure associated with an intermediate fabrication step for aspects of a device in accordance with aspects described herein;

FIG. 4D is cross section perspective illustrating a structure associated with an intermediate fabrication step for aspects of a device in accordance with aspects described herein;

FIG. 4E is cross section perspective illustrating a structure associated with an intermediate fabrication step for aspects of a device in accordance with aspects described herein;

FIG. 4F is cross section perspective illustrating a structure associated with an intermediate fabrication step for aspects of a device in accordance with aspects described herein;

FIG. 4G is cross section perspective illustrating a structure associated with an intermediate fabrication step for aspects of a device in accordance with aspects described herein;

FIG. 4H is an isometric view illustrating aspects of an epitaxial piezoelectric layer formed on a handle wafer in accordance with aspects described herein;

FIG. 5 is a flow diagram illustrating aspects of a method in accordance with aspects described herein;

FIG. 6 is a diagram illustrating an example of an apparatus including an electro-optical device in accordance with aspects described herein;

FIG. 7 is a block diagram illustrating an example computing-device architecture of an example computing device which can include one or more implementations of an electro-optical device in accordance with aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be implemented and/or practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Aspects described herein include acousto-optical modulators used to modulate light via Brillouin scattering in a waveguide. Brillouin scattering is a phenomenon whereby acoustic energy (e.g., phonons) interact with light (e.g., photons). Aspects described herein include a combination of electroacoustic resonators formed on a piezoelectric layer and an optical waveguide also formed on top of the piezoelectric layer. The electroacoustic resonator can be designed with an acoustic resonance characteristic configured to efficiently create Brillouin scattering in the waveguide to facilitate a particular impact on light within the waveguide. Depending on the design of the modulator, this can include modulating an optical mode that the light is in within the waveguide, modulating a wavelength of light within the waveguide, or modulating a phase of light within the waveguide.

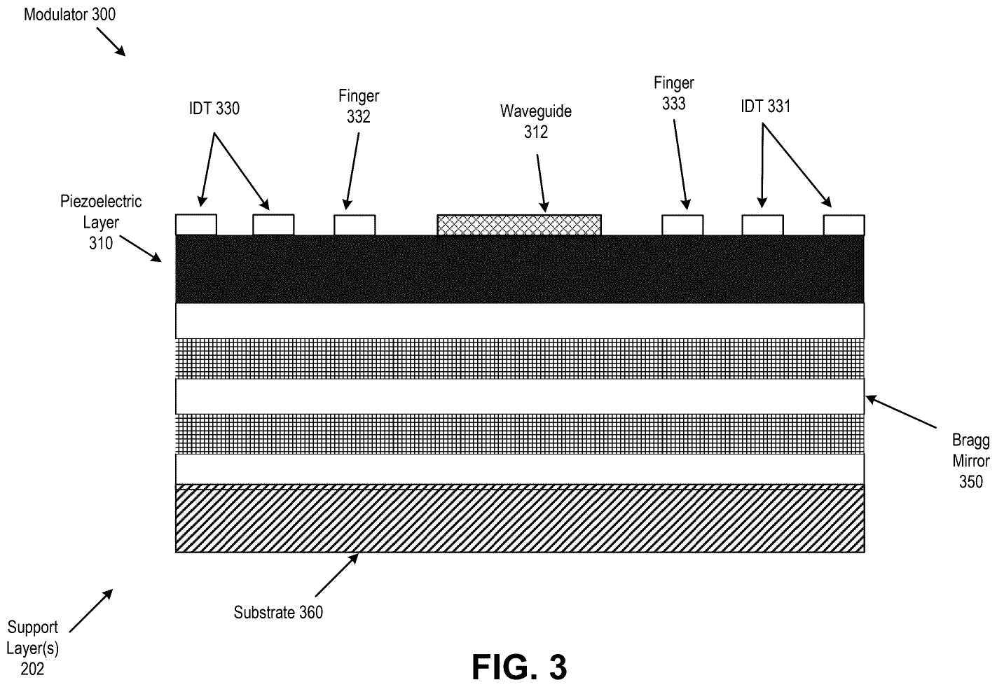

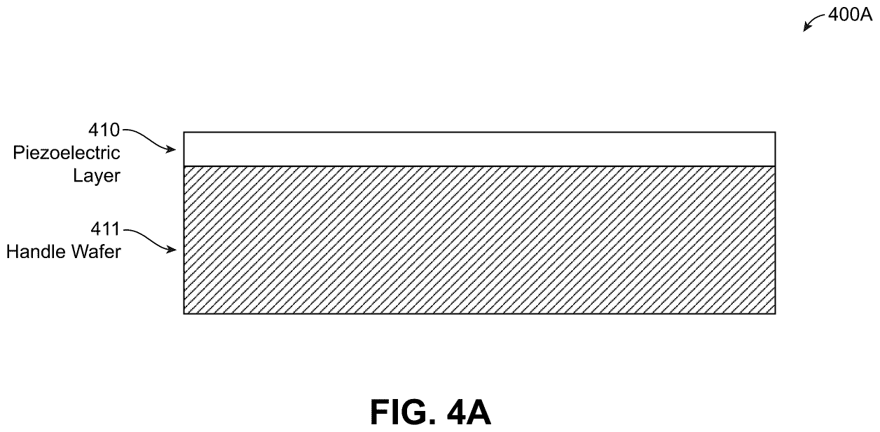

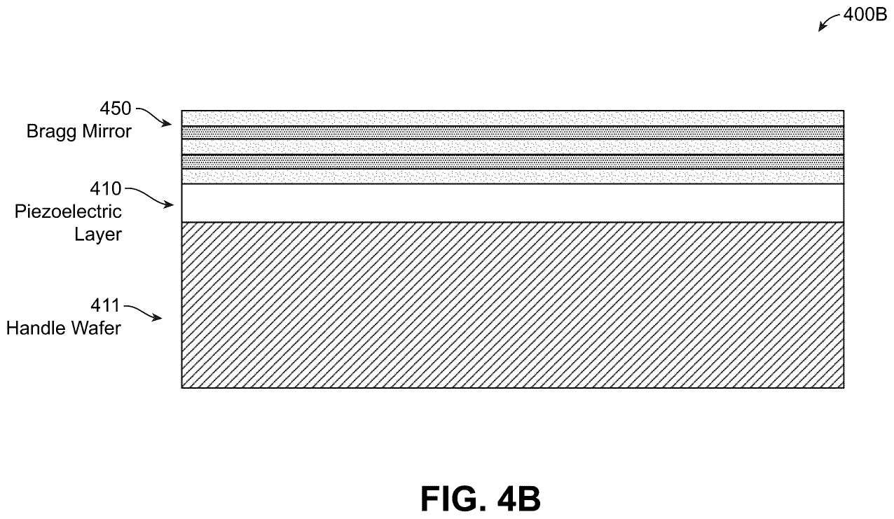

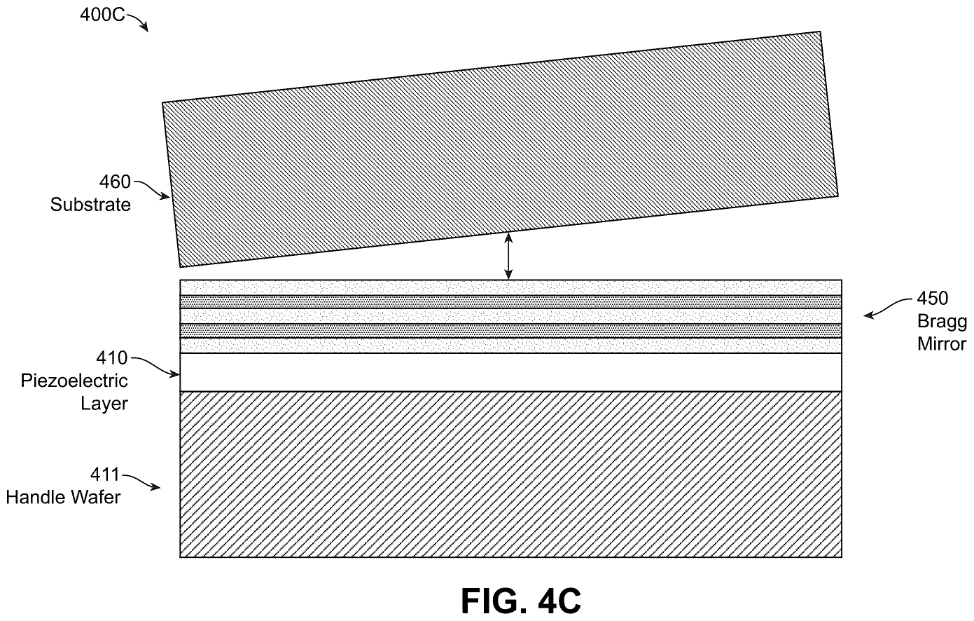

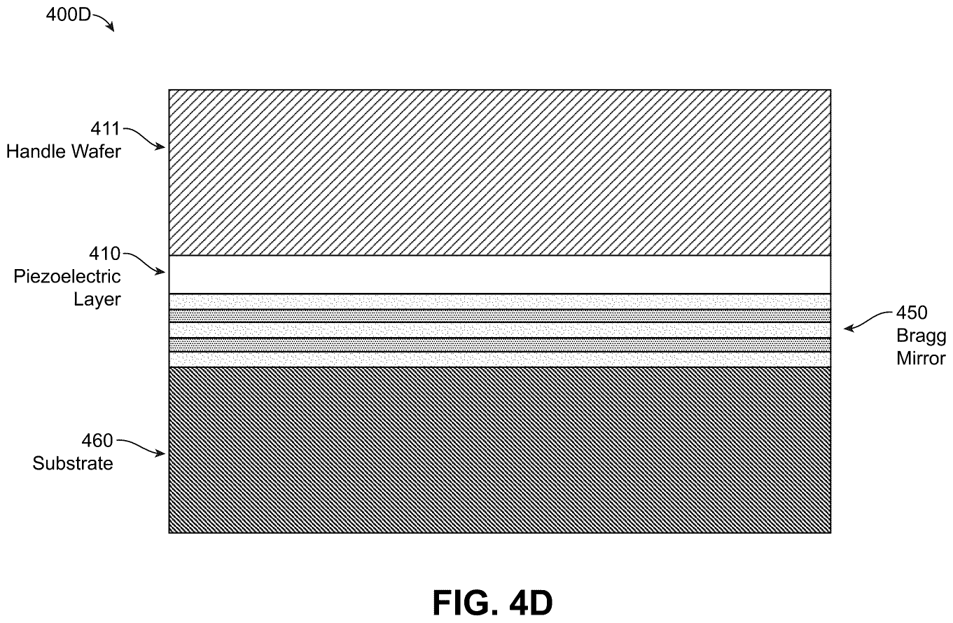

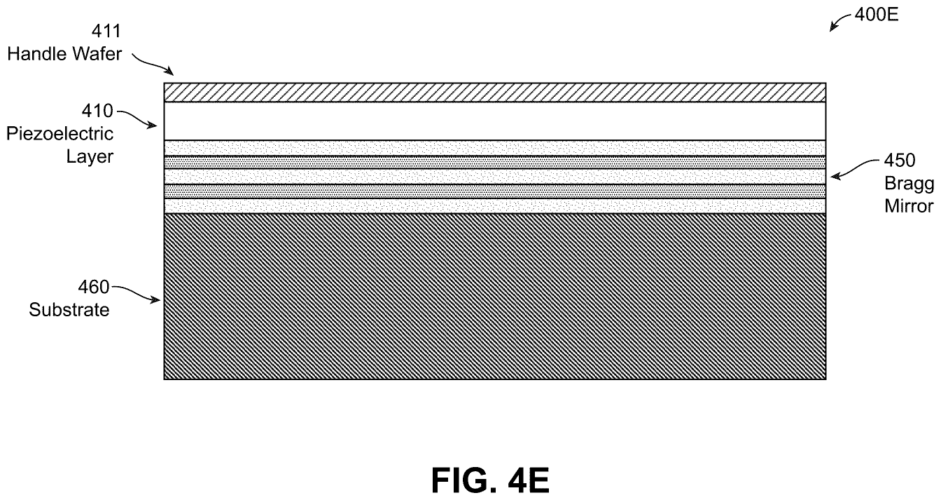

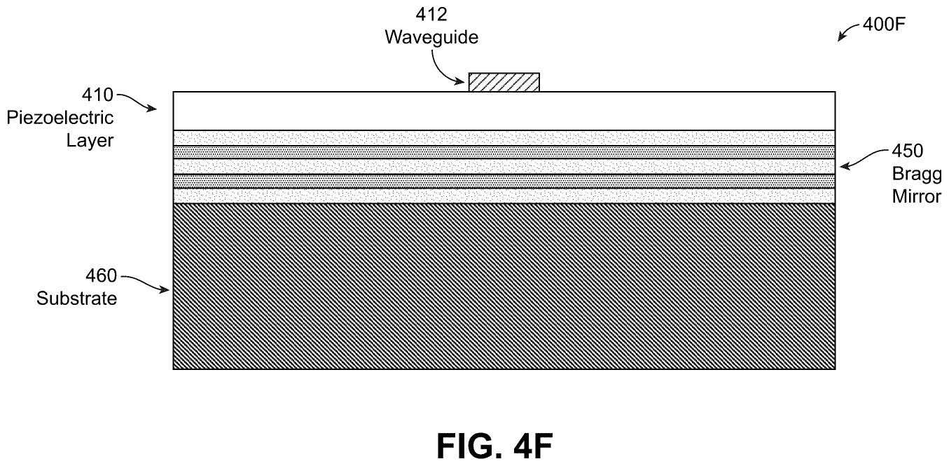

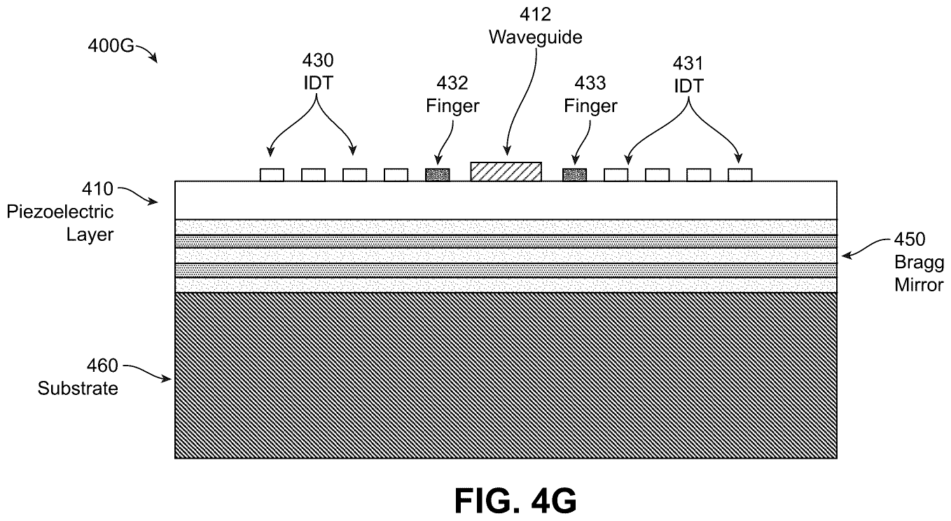

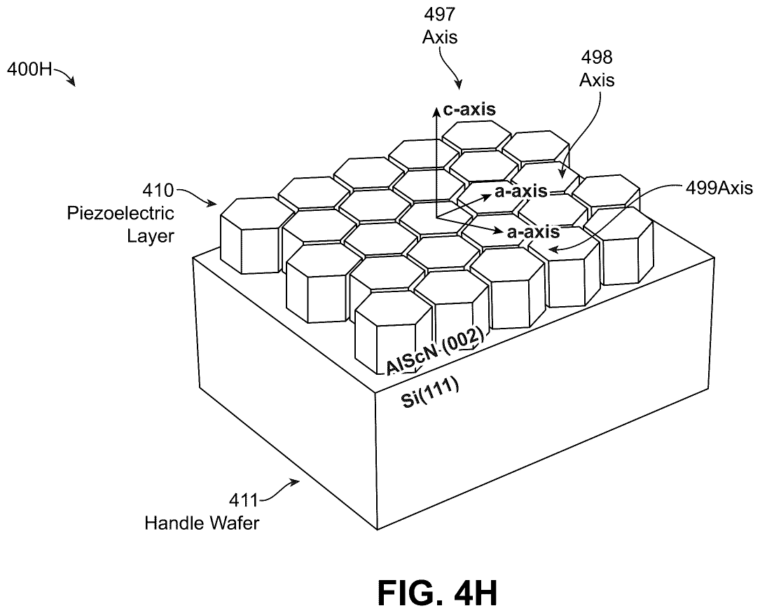

In accordance with aspects described herein, aluminum scandium nitride (AlScN) and lithium niobate (LiNbO₃ or LN) are two materials that can be used for a piezoelectric layer including a waveguide and IDTs for electroacoustic resonance on a top surface of the piezoelectric layer. In other aspects, aluminum nitride (AlN) may be used. In further aspects, other materials can be used. The process aspects described in detail (e.g., in FIGS. 4A-G) particularly relate to AlScN implementations. It will be apparent that other processes can be used for implementations using alternative materials for the piezoelectric layers in accordance with aspects described herein (e.g., the structure of FIGS. 3, 4G, etc.)

Some aspects described herein particularly relate to solidly mounted modulator structures which can be fabricated leveraging existing process operations to generate a high quality piezoelectric layer with an associated high piezoelectric coefficient, as well as improved acoustic stress performance and modulator efficiency. When compared with existing modulators configured with silicon optical waveguides configured in a membrane structure, aspects described herein provide improved mechanical stability and a high modulator efficiency using established manufacturing processes.

Additional details are provided below with respect to the figures.

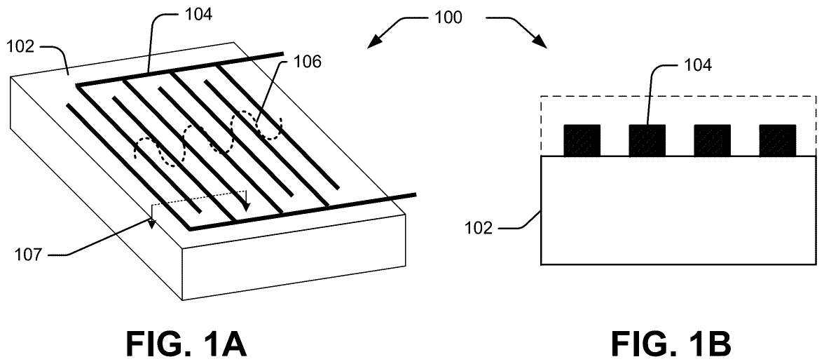

FIG. 1A is a diagram of a perspective view of an example of an electroacoustic resonator that can be implemented as part of an electroacoustic device 100. The electroacoustic device 100 may be configured as a portion of an acousto-optical modulator in accordance with aspects described herein. The electroacoustic device 100 includes an electrode structure 104, that may be referred to as an interdigital transducer (IDT), on the surface of a piezoelectric material 102. The electrode structure 104 generally includes first and second comb shaped electrode structures (conductive and generally metallic) with electrode fingers extending from two busbars towards each other arranged in an interlocking manner in between two busbars (e.g., arranged in an interdigitated manner). An electrical signal excited in the electrode structure 104 (e.g., applying an AC voltage) Is transformed into an acoustic wave 106 that propagates in a particular direction via the piezoelectric material 102. The acoustic wave 106 is transformed back into an electrical signal and provided as an output. In many applications, the piezoelectric material 102 has a particular crystal orientation such that when the electrode structure 104 is arranged relative to the crystal orientation of the piezoelectric material 102, the acoustic wave mainly propagates in a direction perpendicular to the direction of the fingers (e.g., parallel to the busbars). In other applications, the operation can be structured where a standing wave is possible and the acoustic wave is not traveling. In some aspects, such a non-propagating acoustic wave pattern is desired, with a standing wave that exhibits components in both x and z directions (e.g., lateral and vertical wave components). Bragg mirrors or cavity structures in accordance with aspects described herein provide isolation in the z-direction. In various examples, circuits described herein having such structures can include micro-electroacoustic resonators implemented with micro-electromechanical structure (MEMS) technology. MEMS technology includes miniature physical structures that can have both mechanical (e.g., vibrational or acoustic) component characteristics as well as electrical characteristics.

FIG. 1B is a diagram of a side view of the electroacoustic device 100 of FIG. 1A along a cross-section 107 shown in FIG. 1A. The electroacoustic device 100 is illustrated by a simplified layer stack including a piezoelectric material 102 with an electrode structure 104 disposed on the piezoelectric material 102. The electrode structure 104 is conductive and generally formed from metallic materials. The piezoelectric material 102 may be extended with multiple interconnected electrode structures disposed thereon to form a resonator with multiple IDTs. Electrical vias or bumps that allow the component to be electrically connected to connections on a substrate (e.g., via flip-chip or other techniques) may also be included.

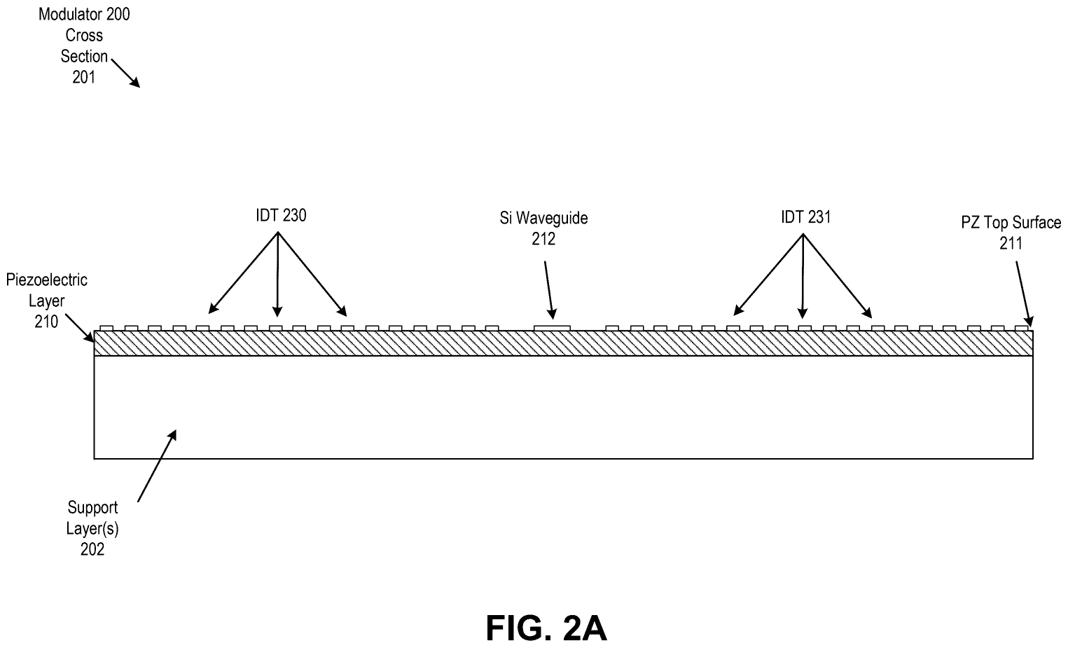

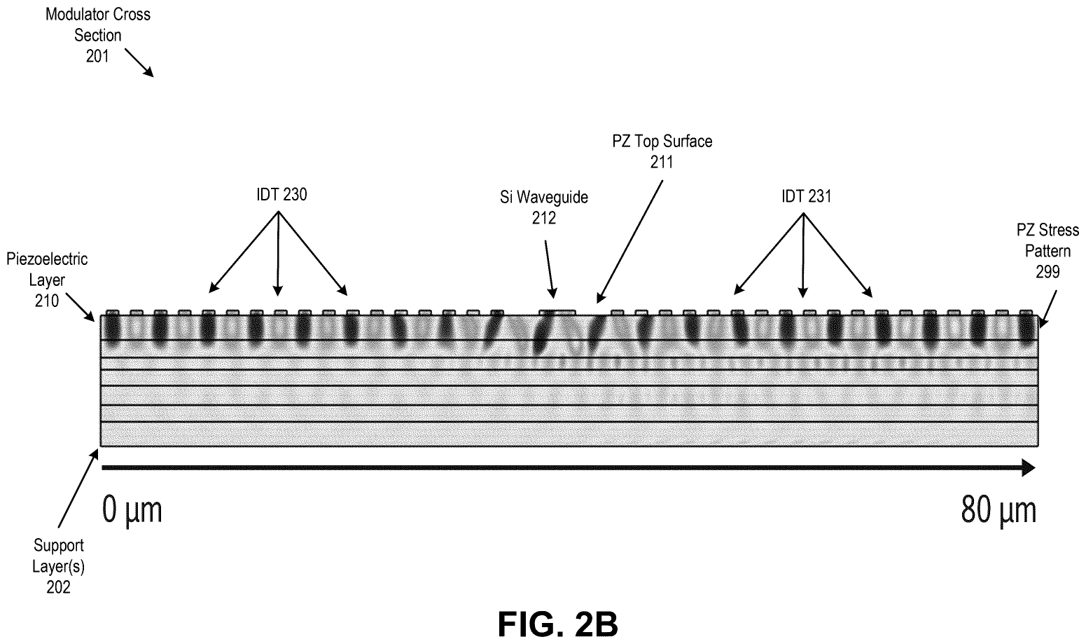

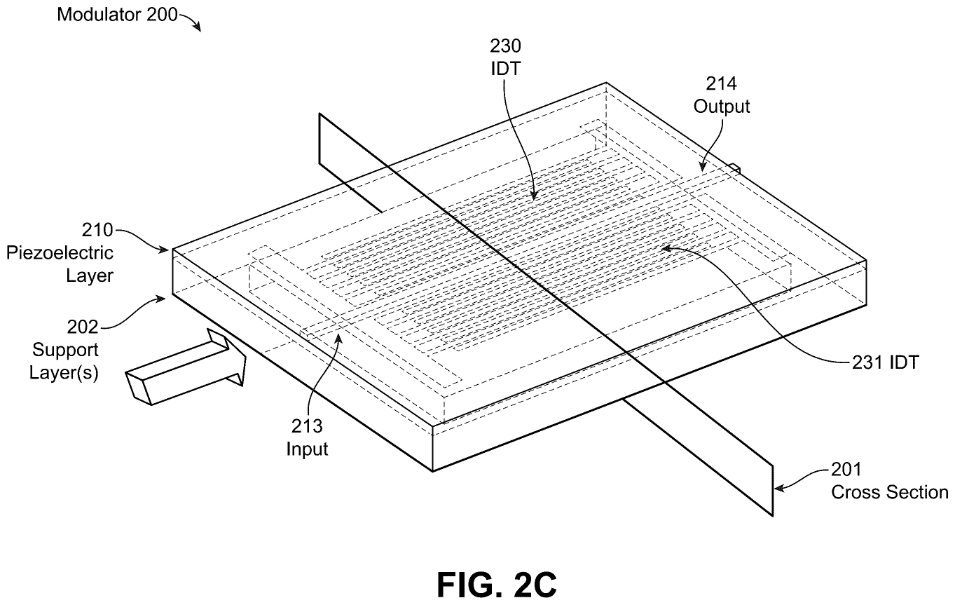

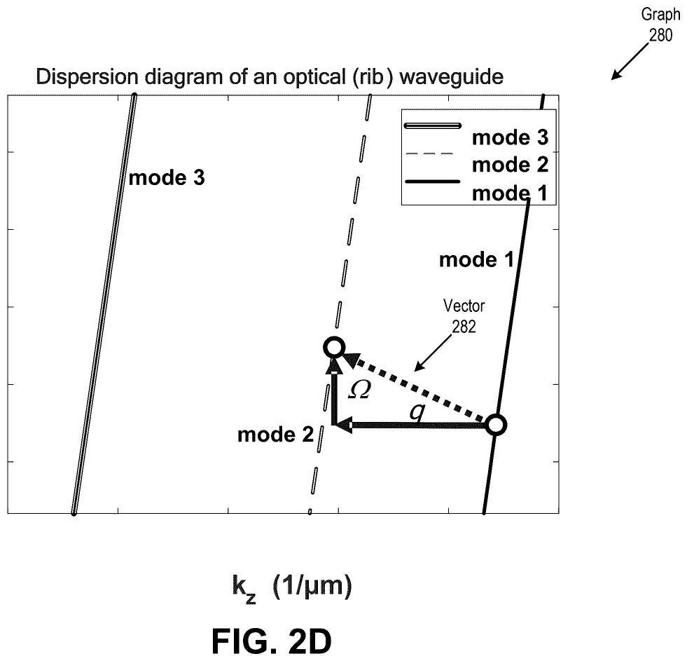

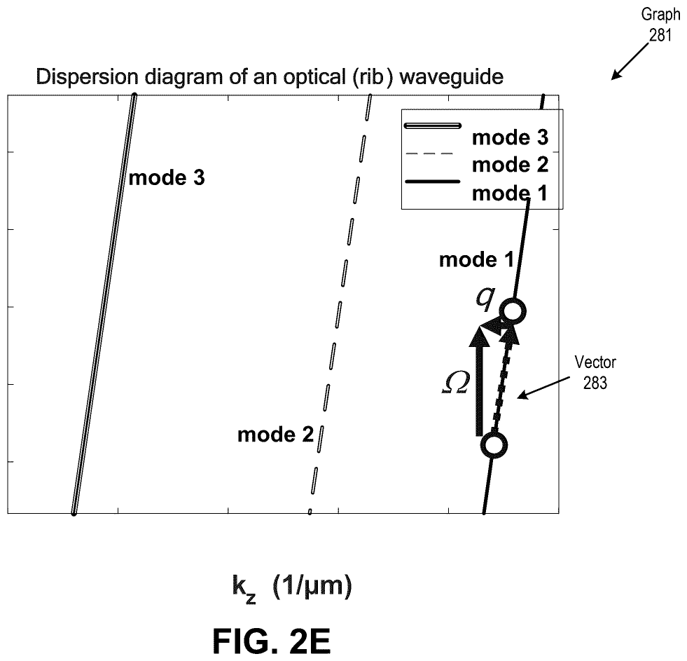

FIG. 2A is a cross section perspective 201 of aspects of an acousto-optical modulator 200 in accordance with aspects described herein. As illustrated, the acousto-optical modulator 200 includes a piezoelectric layer 210. The piezoelectric layer 210 is formed with a waveguide 212 protruding from a top surface 211. As indicated above, AlScN (e.g., Al(1-x)Sx(x)N where x is a value between 0 and 0.45) or LN can be used as a material for the piezoelectric layer. Such materials provide improved modulation efficiency via the high piezoelectric coupling of these materials. In other implementations, other materials, such as AlN may be used. The waveguide 212 is a shape extending upwards away from support layers 202, which allows for one or more optical modes that guide light along the waveguide 212 and an area of the piezoelectric layer 210 below the waveguide. The particular geometry of the protrusion associated with the waveguide determines the optical modes available for guiding light and for modulating light within or between modes via Brillouin scattering as detailed further below.

The acousto-optical modulator 200 further includes an interdigital transducer 230 and an interdigital transducer 231. Each of the interdigital transducers 230, 231 can be configured similar to the electrode structure 104 discussed above. In some aspects, the interdigital transducers 230, 231 can be configured as two halves of a single interdigital transducer with shared busbars coupled around or across the waveguide 212. In other aspects, the interdigital transducers 230, 231 can be separated with different electrical connections configured for a particular acousto-optical modulation associated with a given implementation.

In the example of FIG. 2A, the interdigital transducer 230 is disposed on the top surface 211 on a first side of the waveguide, and the interdigital transducer 231 is positioned on a second side of the waveguide 212 opposite the first side where the interdigital transducer 230 is positioned.

FIG. 2B is cross section perspective of aspects of an acousto-optical modulator 200 in accordance with aspects described herein. The perspective of FIG. 2B illustrates a similar view as the cross section perspective 201, but with an illustration of a stress pattern 299 caused by acoustic vibrations associated with operation of the interdigital transducers 230, 231. As illustrated, the position and design (e.g., pitch or space between fingers, finger size, etc.) are configured such that when electrical signals pass through the interdigital transducers 230, 231, acoustic waves are generated in the piezoelectric layer 210 and the support layer(s) 202. The configuration can be selected for a resonance at certain electrical and acoustic frequencies. The acoustic waves cause the stress pattern 299 from the vibrations (e.g., acoustic waves) in the material of the piezoelectric layer 210 and the support layer(s) 202. Even though the waveguide 212 is not active in the electroacoustic interaction that generates the stress pattern 299, the stress pattern repeats within the waveguide 212 area, resulting in the illustrated double stress node in the waveguide 212 area.

FIG. 2C is an isometric view of one implementation of the acousto-optical modulator 200 in accordance with aspects described herein. FIG. 2C, in addition to showing the elements of FIGS. 2A and 2B, shows how the cross section perspective 201 illustrated in FIGS. 2A and 2B relate to the isometric illustration of the acousto-optical modulator 200. As shown, the stress pattern 299 exists in the cross section perspective 201, but would also extend along the waveguide 212 where the interdigital transducers 230, 231 generate the acoustic wave. An optical signal (e.g., light) is provided at the input 213 (e.g., a first end of the waveguide) and exits at the output 214 (e.g., a second end of the waveguide) following modulation that occurs due to the Brillouin effect over the length of the waveguide 212. A light source providing an optical wave to the input 213 can be structured as a light generator (e.g., a laser) with a coupling structure (e.g., a grating, edge coupler, etc.), or can be an output from any optical structure that provides a suitable optical signal for the modulator 200.

FIG. 2D is a graph 280 illustrating aspects of inter-modal modulation via Brillouin scattering in accordance with aspects described herein. As indicated above, Brillouin scattering is a physical phenomenon involving the interaction of light and sound (e.g. photons and phonons). Brillouin scattering is a nonlinear process leading to a shift of a photon mode, wavelength, k-vector, and/or phase. Such interactions, while being nonlinear, can be enhanced by managed interactions with a configured acoustic wave interacting with an optical wave confined within modes associated with a waveguide design.

The graph of FIG. 2D is a dispersion diagram showing modes for an optical waveguide. Modes 1, 2, and 3 are lines showing the possible values for light waves for a given waveguide geometry. The vertical axis is a frequency axis, and the horizontal axis is a wavevector axis. The vector 282 illustrates a quantifiable scattering dispersion for light undergoing a mode conversion from mode 1 to mode 2.

Such a mode conversion along the vector 282 operates with a phonon having the following vector properties for the difference between a starting and ending mode of the light:

$$Ω = 2 π {f}_{acoustic} \qquad ( 1 )$$

$$q = 2 π / {λ}_{acoustic} tan ( θ ) \qquad ( 2 )$$

where q is the angle between the normal of the interdigital transducer (e.g., the acoustic wave direction) and the optical waveguide, f_{acoustic} is the frequency of the acoustic wave, and λ_{acoustic} is the wavelength of the acoustic wave. The lines indicated for the modes are given by the shape, dimensions, and materials that make up the associated waveguide.

Referring to the modulator 200 illustrated above, light entering the input 213 of the waveguide 212 in mode 1 when an appropriately designed acoustic wave is present according to the vector properties above will begin to undergo targeted Brillouin scattering (e.g., targeted by the design to achieve a certain change for the modulation effect). For the vector 282, this involves a mode conversion from mode 1 to mode 2. In other aspects, intra-mode scattering may occur. Such scattering is not instantaneous, but will occur over the length of the waveguide based on a mode conversion efficiency that can be defined as β by folding an initial and final electric field E₁ and E₂ with an acoustic stress r:

$$β α \int \int {E}_{1} ( {r}_{⊥} ) {E}_{2} ( {r}_{⊥} ) ( ∇ \cdot u ( {r}_{⊥} ) ) {d}^{2} {r}_{⊥} \qquad ( 3 )$$

The description above relates to inter mode scattering, which can be used to implement inter modal modulation. Other aspects can be used to implement wavelength modulation and phase modulation with both intra modal modulation (e.g., Brillouin scattering along the line of the same mode) and inter modal modulation (e.g., Brillouin scattering between mode lines as illustrated in FIG. 2D) with a given waveguide and acoustic wave design from inter digital transducers.

In the example of modulator 200, modal modulation between mode 1 and mode 2 can be achieved by turning the interdigital transducers on and off to modulate a signal received at input 213 in mode 1 between mode 1 and mode 2 at the output 214. The length of the waveguide 212 can be designed based on the mode conversion efficiency of the modulator 200 to achieve a scattering of the input mode 1 light into mode 2 at the output 214 using Brillouin scattering enhanced by the stress pattern 299. When the interdigital transducers 230, 231 are not generating an acoustic wave and the associated stress pattern 299, the scattering to mode 2 will be relatively small, resulting in the light at the output 214 remaining in mode 1.

FIG. 2E is a graph 281 illustrating aspects of intra-modal modulation via Brillouin scattering in accordance with aspects described herein. The graph 281 of FIG. 2E is similar to the graph 280 of FIG. 2D, but where the graph 280 with the vector 282 shows inter-modal modulation between mode 1 and mode 2, the graph 281 shows vector 283 with intra-modal modulation within mode 1.

The graph of FIG. 2E is a dispersion diagram showing modes for an optical waveguide. In some aspects, similar intra-modal modulation is possible within any of modes 1, 2, and 3. In other waveguide configurations, other modes or modulations are possible in accordance with the details described herein. In FIG. 2E, the vector 282 illustrates a quantifiable scattering dispersion for light undergoing a modulation within mode 1 according to equations 1 and 2 described above. Equation 4 below is an alternative representation of equation 3 above, which describe that a conversion efficiency is proportional to a product of initial and final electric fields of the optical wave and the acoustic stress pattern, integrated over an area (e.g., an area of the cross section of the waveguide such as represented by the waveguide portion of the cross section perspective 201 above). Such relationships apply to both inter- and intra-modal scattering.

$$\int {E}_{initial} \cdot {E}_{final} \cdot \frac{d u}{d x} d A \qquad ( 4 )$$

The Brillouin modulation efficiency for any modulation (e.g., intra-modal, intermodal) is proportional to equation 4 above for a largest integral value for an aligned direction and field symmetry. In equation 4, E represents the initial and final electrical fields integrated with respect to the displacement u and the associated stress du/dx (e.g., associated with the acoustic pressure in the waveguide) over the area A of the waveguide cross section. A largest Brillouin modulation efficiency and greater associated device performance occurs when a largest integral value of equation 4 occurs with an aligned direction and field symmetry.

Just as described above for inter-modal modulation, intra-modal modulation using the modulator 200 can be achieved by turning the interdigital transducers on and off to modulate a signal received at input 213 within mode 1. The length of the waveguide 212 can be designed based on the mode conversion efficiency of the modulator 200 as described by equation 4 to achieve a modulation of the input mode 1 light within mode 1 to achieve a change in the light at the output 214 using Brillouin scattering enhanced by the stress pattern 299. When the interdigital transducers 230, 231 are not generating an acoustic wave and the associated stress pattern 299, the scattering within mode 1 will be relatively small.

FIG. 2B above illustrates a double stress pattern design in the waveguide. Such a double stress node supports both inter- and intra-modal scattering with an efficiency illustrated by equations 3 and 4 above. Other stress patterns (e.g., single stress nodes, triple stress nodes, etc.) may be used in different implementations, with different associated conversion probabilities.

FIG. 3 is cross section perspective of aspects of a solidly mounted modulator 300 in accordance with aspects described herein. The solidly mounted modulator 300 includes interdigital transducers (IDTs) 330, 331 and waveguide 312 on a top surface of a piezoelectric layer 310, similar to the modulator 200 described above. The modulator 300 additionally includes fingers 332 and 333. Finger 332 is positioned between the IDT 330 and the waveguide 312. The finger 333 is positioned between the IDT 331 and the waveguide. In some aspects, the fingers 332 and 333 can be integrated electrically with the adjacent IDT (e.g., the IDT 330 for the finger 332 and the IDT 331 for the finger 333). In some aspects, the fingers 332 and 333 adjacent to the waveguide 312 can interfere with optical transmission in the waveguide 312, leading to unwanted optical losses or other negative performance impacts. In order to maintain consistent acoustic performance across the piezoelectric layer 310, fingers 332 and 333 can be maintained as “dummy” fingers, rather than eliminating the fingers or positioning the IDTs further away from the waveguide 312 (e.g., which would remove the weight of the fingers from the piezoelectric layer 310 and impact acoustic performance). Such dummy fingers 332 and 333 can be formed as disconnected fingers, or as non-conductive dielectric fingers.

FIG. 3 includes a more specific implementation of the support layer(s) 202 from FIGS. 2A-C, shown as a substrate 360 and a Bragg mirror 350 between the substrate 360 and the piezoelectric layer 310. The Bragg mirror is made up of alternating low impedance (Z) material layers, and high Z material layers. A bottom low Z layer is formed on the substrate 360, and a top low Z layer is formed under the piezoelectric layer 310, and alternating layers of high Z and low Z material are positioned in between. The Bragg mirror 350 operates to maintain acoustic energy in the piezoelectric layer 310, thereby increasing the mode conversion efficiency, and reducing the length of the modulator 300 needed to achieve adequate modulation conversion for a given modulator design. In some implementations, the low Z material layers can comprise silicon oxide (SiO2), fluorine doped silicon dioxide (SiOF), or silicon oxycarbide (SiOC). In some implementations, the high Z material layers can comprise aluminum nitride (AlN), tungsten (W), hafnia (HfO2), hafnium nitride (HfN), or tantalum pentoxide (Ta2O5). In various implementations, other materials or combinations of any such materials with other materials can be used to achieve mechanical stability with acoustic isolation for a solidly mounted acousto-optical modulator similar to the modulator 300 described above. In various aspects, different layer pair numbers may be used based on the particular materials for an implementation of the Bragg mirror 350. For example, a Bragg mirror comprising HfO2 and SiO2 may include 3.5 layer pairs (e.g., 7 layers), while a Bragg mirror comprising AlN and SiO2 may comprise 4.5 layer pairs (e.g., 9 layers). In other aspects, at least one high Z layer and at least two low Z layers of any materials above can be used. In further aspects, other Bragg mirror configurations may be used to achieve targeted performance for a particular device implementation. Acoustically, W/SiO2 provides a largest impedance difference, followed by HfO2/SiO2 and AlN/SiO2 layer pairs. For pairs with lower impedance differences, more layers are used to achieve a similar mirror reflectivity as impedance differences become smaller.

FIG. 4A is cross section perspective illustrating a structure 400A associated with an intermediate fabrication step for aspects of a device in accordance with aspects described herein. A solidly mounted device in accordance with aspects described herein can begin with a handle wafer 411. The handle wafer is formed out of the material that will eventually provide material for a waveguide structure. In some aspects, the handle wafer 411 is formed of silicon (Si). In other aspects, other material can be used. A piezoelectric layer 410 is then formed on a surface of the handle wafer 411. The piezoelectric layer 410 can be grown on the surface of the handle wafer 411 as an epitaxial AlScN piezoelectric layer having a top surface and a bottom surface, resulting in the structure 400A.

In alternate aspects, rather than using a Si handle wafer, silicon nitride can be used for the waveguide. For such implementations, rather than using a handle wafer to form the waveguide as described below, the material of the handle wafer 411 would be completely etched and SiN deposited on top of the (layer-transferred) AlScN.

FIG. 4B is cross section perspective illustrating a structure 400B associated with an intermediate fabrication step for aspects of a device in accordance with aspects described herein. After growth of the piezoelectric layer 410 (e.g., as the epitaxial AlScN layer or another piezoelectric material layer), a Bragg mirror is formed is layers on the exposed surface of the piezoelectric layer 410 (e.g., the bottom layer opposite the handle wafer 411). In some aspects, the Bragg mirror 450 is optional. The Bragg mirror 450 can be formed using any materials or number of layers described above. Different materials can provide different benefits and performance levels. For example, use of silicon oxide (SiO2) with tungsten (W) can provide equivalent or superior performance to a less stable membrane structure in some implementations. Additionally, certain materials can be structured with different numbers of layers. For example, a HfO2 and SiO2 Bragg mirror may operate with 7 layers, while an AlN and SiO2 Bragg mirror may use 9 layers (e.g., 4.5 layer pairs) to achieve acceptable performance, resulting in a thicker device.

FIG. 4C is cross section perspective illustrating a structure 400C associated with an intermediate fabrication step for aspects of a device in accordance with aspects described herein. After fabrication of the Bragg mirror 450 (if any), a substrate 460 is bonded to the bottom surface of the structure 400C to provide a completed set of support layers (e.g., support layer(s) 202). As indicated above, the substrate 460 can be a silicon wafer that can be integrated with other devices, such as CMOS devices or other device technologies or packaging.

FIG. 4D is cross section perspective illustrating a structure 400D associated with an intermediate fabrication step for aspects of a device in accordance with aspects described herein. The perspective of FIG. 4D flips from the perspective of FIG. 4C, with the handle wafer 411 now shown on top. FIG. 4E is cross section perspective illustrating a structure 400E associated with an intermediate fabrication step for aspects of a device in accordance with aspects described herein, with the handle wafer 411 thinned as part of the structuring of a waveguide on a top surface of the piezoelectric layer 410.

As indicated above, some aspects, rather than using a Si handle wafer, SiN can be used for the waveguide. For such implementations, the thinning operation illustrated in FIG. 4E would remove the material of the handle wafer 411 entirely. A SiN waveguide would then be deposited on the top surface of the piezoelectric layer 410.

FIG. 4F is cross section perspective illustrating a structure 400F associated with an intermediate fabrication step for aspects of a device in accordance with aspects described herein. In the structure 400F, the handle wafer 411 is structured into the waveguide 412. As discussed above with respect to equation 4, the overall structure of the waveguide with an IDT is designed to align an electrical field symmetry with a piezoelectric alignment to provide efficient Brillouin modulation and an associated improved device performance. To achieve such efficiency for a stress/displacement design with a single displacement per electrode finger and for the waveguide, the dimensions of the waveguide (e.g., height and width) are similar to or proportional to the dimensions of fingers of the IDT(s). A thickness can be selected to manage leakage of optical energy into the piezoelectric layer, which can occur with a thin waveguide design. In some aspects, the waveguide thickness can be structure to harvest a high stress field in the piezoelectric layer 410.

In other aspects, other width and height relationships can be used for alternate stress patterns within a waveguide for different device operation (e.g., a double stress node inside a waveguide instead of a single stress node) in order to design different device function (e.g., inter-modal modulation vs intra-modal modulation as illustrated in FIGS. 2D-E).

FIG. 4G is cross section perspective illustrating a structure 400G associated with an intermediate fabrication step for aspects of a device in accordance with aspects described herein. FIG. 4G illustrates the final structure of a device without supporting integration (e.g., electrical connections, etc.) that can be implemented as part of a particular implementation. The structure 400G includes the IDTs 430, 431 (e.g., similar to the IDTs 330, 331) as well as the fingers 432, 433 (e.g., non-conductive or dielectric “dummy” fingers). The illustrated intermediate structures of FIGS. 4A-G can be used not only for modulators as described herein, but can also be used for other devices, such as frequency comb devices, optical isolator devices, circulators, and other such devices. Additionally, methods to fabricate a device matching a progression through the structures 400A-G can further include additional structures to integrate additional elements of a device, such as CMOS-compatible integration structures, particularly for implementations with AlScN piezoelectric layers, or other such elements of a device.

FIG. 4H is an isometric view illustrating aspects of the epitaxial AlScN piezoelectric layer 410 as formed on the handle wafer 411, as described above. As shown, FIG. 4H illustrates the oriented AlScN layer 410 formed on or above a Si oriented substrate (e.g., the handle wafer 411). Epitaxial refers to a material structure where a relationship between the lattice constants of the substrate (e.g., the handle wafer 411) and lattice constants of a material grown in a shared out-of-plane and in-plane orientation on a surface of the substrate (e.g., the piezoelectric layer 410 grown on the handle wafer 411). The epitaxial structure allows the AlScN grains to be grown in the same out-of-plane and in-plane orientation on top of the silicon substrate (e.g., the handle wafer 411). For a piezoelectric material, this differs from a fiber-textured or non-epitaxial structure where the a-axis is randomly oriented in-plane (e.g., parallel to the surface of the substrate on which the piezoelectric material is formed).

The ordered structure of the epitaxial piezoelectric layer 410 is shown in FIG. 4H by the illustrated a-axis 498 and a-axis 499. In a non-epitaxial piezoelectric layer (not shown), the surface plane orientation would be random, with no associated axis corresponding to axis 498 and 499. For both material structures (e.g., epitaxial and non-epitaxial), the crystal c-axis 497 is perpendicular to the surface of the substrate as shown by FIG. 4H.

The above-described structures 400A-H can be used to create devices using processes established as reliable fabrication operations, and can be used to fabricate devices with added mechanical stability when compared to standard membrane device, and comparable performance. Such improved mechanical stability can provide significant benefits for device designs where device lengths are long (e.g., greater than 1 millimeter (mm)) and membrane structures for existing devices are thin (e.g., less than 1 micrometer (μm)). The performance can additionally depend on the device design in accordance with aspects described herein being implemented to achieve high acoustic stress and associated modulator efficiencies in the context of established manufacturing processes.

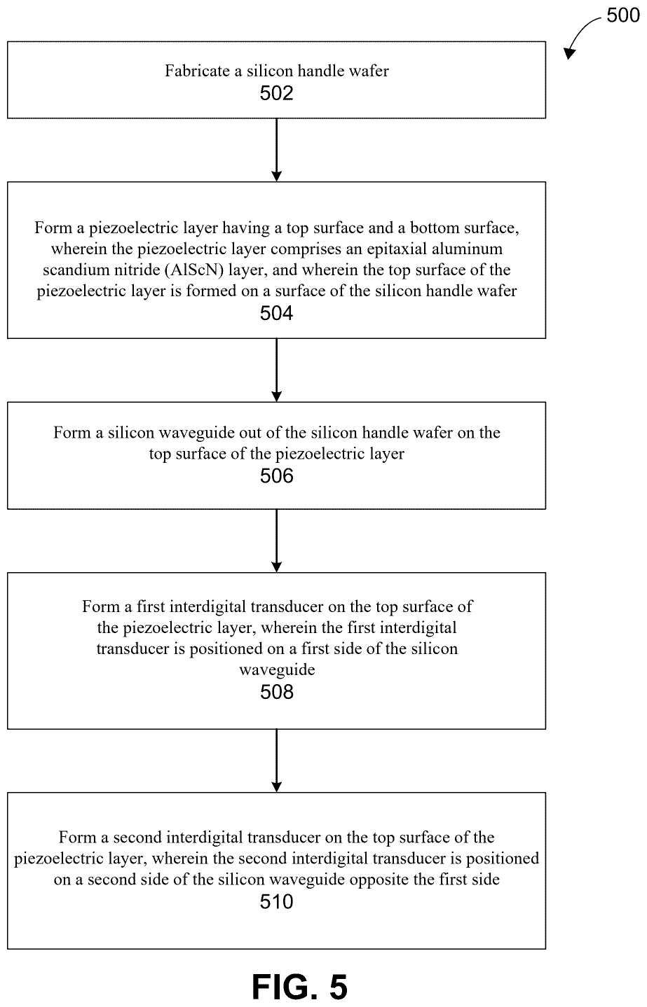

FIG. 5 is a block diagram illustrating a method 500 of fabricating a device using an AlScN piezoelectric layer with an Si waveguide in accordance with aspects described herein. In some implementations, the method 500 can be implemented as computer readable instructions that, when executed by one or more processors of a system or device, cause the system or device to perform operations in accordance with the method 500. In other aspects, the method 500 can be implemented as a system or device comprising one or more processors that are configured to initiate operations in accordance with the method 500.

At block 502, the system or device fabricates a silicon handle wafer (e.g., the handle wafer 411 of any of FIGS. 4A-4E described herein).

At block 504, the system or device forms a piezoelectric layer having a top surface and a bottom surface. The piezoelectric layer includes an epitaxial aluminum scandium nitride (AlScN) layer. The top surface of the piezoelectric layer is formed on a surface of the silicon handle wafer. For instance, with reference to FIGS. 4A-4E as an illustrative example, the piezoelectric layer 410 can be formed on a surface of the handle wafer 411. In some cases, the piezoelectric layer 410 can be grown on the surface of the handle wafer 411 as an epitaxial AlScN piezoelectric layer having a top surface and a bottom surface.

At block 506, the system or device forms a silicon waveguide (e.g., the waveguide 412 of FIGS. 4F and 4G) out of the silicon handle wafer on the top surface of the piezoelectric layer. For instance, referring to FIG. 4F and FIG. 4G as an illustrative example, the waveguide in FIGS. 4F and 4G can be formed from the handle wafer 411.

At block 508, the system or device forms a first interdigital transducer (e.g., IDT 430 of FIG. 4G) on the top surface of the piezoelectric layer. The first interdigital transducer is positioned on a first side of the silicon waveguide.

At block 510, the system or device forms a second interdigital transducer (e.g., IDT 431 of FIG. 4G) on the top surface of the piezoelectric layer. The second interdigital transducer is positioned on a second side of the silicon waveguide opposite the first side.

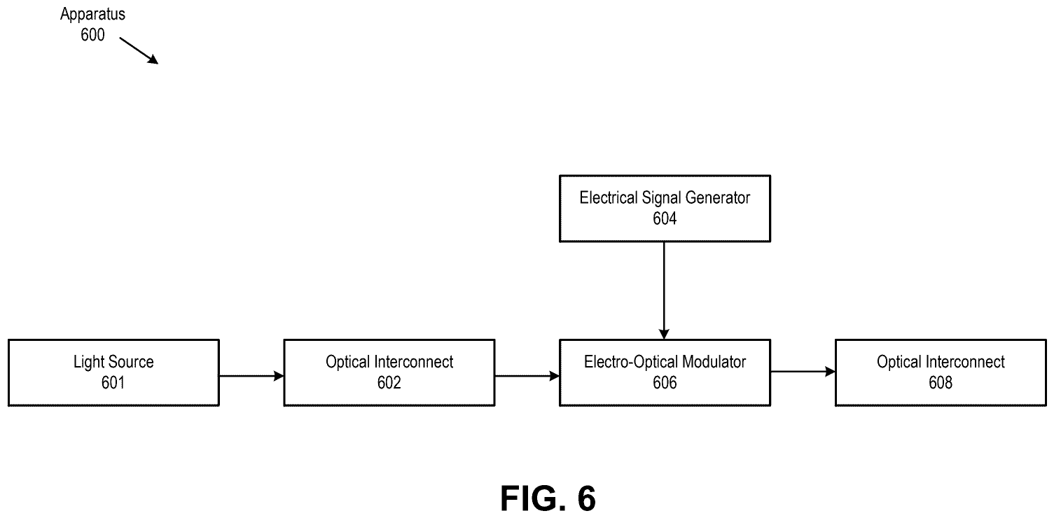

FIG. 6 is a diagram illustrating an example of an apparatus 600 including an acousto-optical modulator 606 in accordance with aspects described herein. The apparatus, in addition to the electro-optical modulator 606, includes a light source 601, an optical interconnect 602 coupling the light source 601 to the electro-optical modulator 606, an output optical interconnect 608 at an output of the acousto-optical modulator 606, and an electrical signal generator 604 coupled to the acousto-optical modulator.

The light source 601 is a continuous wave (CW) light source that provides input light to the acousto-optical modulator 606 to be modulated. The optical interconnects 602 and 608 can be structures for coupling light between waveguides of different materials (e.g., a waveguide of the acousto-optical modulator and silicon or other waveguides associated with the light source 601 and/or a transmission media, such as an optical fiber). The electrical signal generator 604 can be communication circuitry configured to upconvert data from control circuitry (e.g., from memory or other data sources of a computing apparatus) to Rf or microwave frequencies. The electrical signal generator 604 can be coupled to a signal waveguide of the acousto-optical modulator 606, as illustrated in additional detail described above.

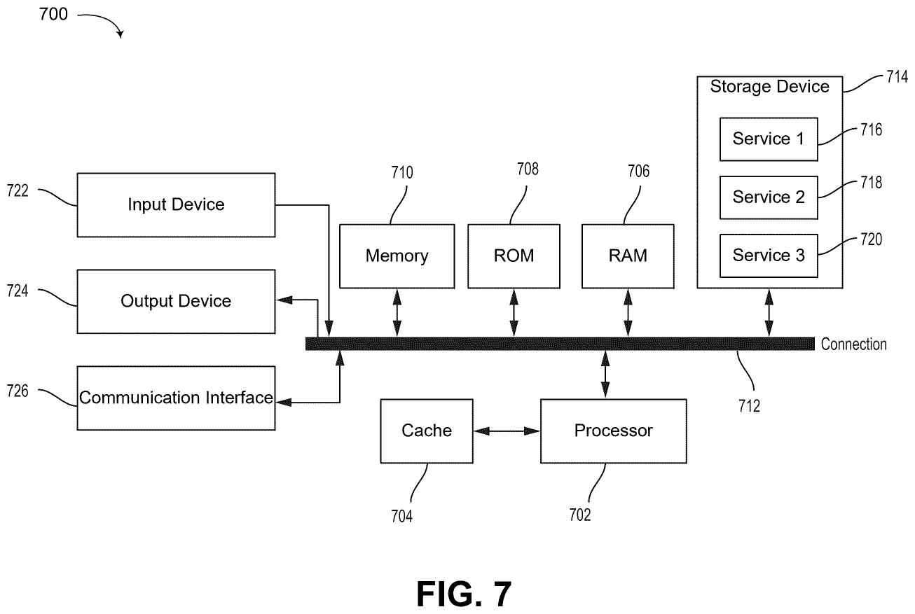

FIG. 7 illustrates an example computing-device architecture 700 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the communication interface 726 of the computing-device architecture 700 may include implementations of the electro-optical modulators 106A/106B or any implementation of an electro-optical modulator in accordance with aspects described herein. Additionally, the computing-device architecture 700 can include any number of output devices 724 or elements of the communication interface 726, or integration of other devices or elements that include electro-optical modulators as described herein.

The components of computing-device architecture 700 are shown in electrical communication with each other using connection 712, such as a bus. The example computing-device architecture 700 includes a processing unit (CPU or processor) 702 and computing device connection 712 that couples various computing device components including computing device memory 710, such as read only memory (ROM) 708 and random-access memory (RAM) 706, to processor 702.

Computing-device architecture 700 can include a cache of high-speed memory connected directly with, in close proximity to, or integrated as part of processor 702. Computing-device architecture 700 can copy data from memory 710 and/or the storage device 714 to cache 704 for quick access by processor 702. In this way, the cache can provide a performance boost that avoids processor 702 delays while waiting for data. These and other modules can control or be configured to control processor 702 to perform various actions. Other computing device memory 710 may be available for use as well. Memory 710 can include multiple different types of memory with different performance characteristics. Processor 702 can include any general-purpose processor and a hardware or software service, such as service 1 716, service 2 718, and service 3 720 stored in storage device 714, configured to control processor 702 as well as a special-purpose processor where software instructions are incorporated into the processor design. Processor 702 may be a self-contained system, containing multiple cores or processors, a bus, memory controller, cache, etc. A multi-core processor may be symmetric or asymmetric.

To enable user interaction with the computing-device architecture 700, input device 722 can represent any number of input mechanisms, such as a microphone for speech, a touch-sensitive screen for gesture or graphical input, keyboard, mouse, motion input, speech and so forth. Output device 724 can also be one or more of a number of output mechanisms known to those of skill in the art, such as a display, projector, television, speaker device, etc. In some aspects, the interfaces for such devices can include the use of an electro-optical modulator to communicate data in accordance with aspects described herein. In some instances, multimodal computing devices can enable a user to provide multiple types of input to communicate with computing-device architecture 700. Communication interface 726 can generally govern and manage the user input and computing device output, and can use electro-optical modulators to encode data for communication via the communication interface 726. There is no restriction on operating on any particular hardware arrangement and therefore the basic features here may easily be substituted for improved hardware or firmware arrangements as they are developed.

Storage device 714 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 706, read only memory (ROM) 708, and hybrids thereof. Storage device 714 can include services 716, 718, and 720 for controlling processor 702. Other hardware or software modules are contemplated. Storage device 714 can be connected to the computing device connection 712. In one aspect, a hardware module that performs a particular function can include the software component stored in a computer-readable medium in connection with the necessary hardware components, such as processor 702, connection 712, output device 724, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. In some aspects, light detection and ranging (LiDAR) functionality of any such device can be implemented using aspects described herein. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), Flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An acousto-optical device comprising: a piezoelectric layer comprising a top surface and a bottom surface; a waveguide on the top surface of the piezoelectric layer; a first interdigital transducer disposed on the top surface of the piezoelectric layer, wherein the first interdigital transducer is positioned on a first side of the waveguide; and a second interdigital transducer disposed on the top surface of the piezoelectric layer, wherein the second interdigital transducer is positioned on a second side of the waveguide opposite the first side.

Aspect 2. The acousto-optical device of Aspect 1, wherein the piezoelectric layer comprises epitaxial aluminum scandium nitride (AlScN).

Aspect 3. The acousto-optical device of any of Aspects 1 or 2, wherein the waveguide comprises silicon positioned on the piezoelectric layer by depositing the piezoelectric layer on a silicon handle wafer and forming the waveguide from the silicon handle wafer.

Aspect 4. The acousto-optical device of any of Aspects 1 or 2, wherein the waveguide comprises silicon nitride (SiN).

Aspect 5. The acousto-optical device of any of Aspects 1 to 4, further comprising: a first dummy finger formed between the first interdigital transducer and the waveguide; and a second dummy finger formed between the second interdigital transducer and the waveguide.

Aspect 6. The acousto-optical device of Aspect 5, wherein the first dummy finger and the second dummy finger comprise a non-conductive dielectric material.

Aspect 7. The acousto-optical device of any of Aspects 1 to 6, further comprising: a Bragg mirror, wherein the piezoelectric layer is positioned on a top surface of the Bragg mirror; and a silicon substrate, wherein a bottom surface of the Bragg mirror is positioned on the silicon substrate.

Aspect 8. The acousto-optical device of Aspect 7, wherein the Bragg mirror comprises alternating layers of high impedance material and low impedance material comprising at least: a top low impedance layer positioned at the bottom surface of the piezoelectric layer, a bottom low impedance layer formed at an interface with the silicon substrate, and an intermediate high impedance layer between the top low impedance layer and the bottom low impedance layer.

Aspect 9. The acousto-optical device of Aspect 8, wherein the alternating layers comprise at least two low impedance silicon oxide (SiO2) layers and at least one high impedance tungsten (W) layer.

Aspect 10. The acousto-optical device of Aspect 8, wherein the alternating layers comprise at least one high impedance aluminum nitride (AlN) layers.

Aspect 11. The acousto-optical device of Aspect 8, wherein the alternating layers comprise four low impedance silicon oxide (SiO2) layers and three high impedance hafnia (HfO2) layers.

Aspect 12. A solidly mounted acousto-optic device formed by a method comprising: fabricating a silicon handle wafer; forming a piezoelectric layer having a top surface and a bottom surface, wherein the piezoelectric layer comprises an epitaxial aluminum scandium nitride (AlScN) layer, and wherein the top surface of the piezoelectric layer is formed on a surface of the silicon handle wafer; forming a silicon waveguide out of the silicon handle wafer on the top surface of the piezoelectric layer; forming a first interdigital transducer on the top surface of the piezoelectric layer, wherein the first interdigital transducer is positioned on a first side of the silicon waveguide; and forming a second interdigital transducer on the top surface of the piezoelectric layer, wherein the second interdigital transducer is positioned on a second side of the silicon waveguide opposite the first side.

Aspect 13. The solidly mounted acousto-optic device of Aspect 12, wherein the method further comprises: forming a Bragg mirror having a top surface and a bottom surface, wherein the top surface is formed on the bottom surface of the piezoelectric layer.

Aspect 14. The solidly mounted acousto-optic device of Aspect 13, wherein the method further comprises bonding a silicon device wafer to the bottom surface of the Bragg mirror.

Aspect 15. The solidly mounted acousto-optic device of Aspect 14, wherein the Bragg mirror comprises alternating layers of high impedance material and low impedance material.

Aspect 16. The solidly mounted acousto-optic device of Aspect 14, wherein the Bragg mirror comprises alternating layers of material selected from combinations of silicon oxide (SiO2) and tungsten (W), SiO2 and aluminum nitride (AlN), or SiO2 and hafnia (HfO2).

Aspect 17. A solidly mounted acousto-optical device comprising: an epitaxial aluminum scandium nitride (AlScN) piezoelectric layer comprising a top surface and a bottom surface; a silicon (Si) waveguide on the top surface of the piezoelectric layer; a first interdigital transducer disposed on the top surface of the piezoelectric layer, wherein the first interdigital transducer is positioned on a first side of the waveguide; and a second interdigital transducer disposed on the top surface of the piezoelectric layer, wherein the second interdigital transducer is positioned on a second side of the waveguide opposite the first side.

Aspect 18. The acousto-optical device of Aspect 17, further comprising: a first dummy finger formed between the first interdigital transducer and the waveguide; and a second dummy finger formed between the second interdigital transducer and the waveguide.

Aspect 19. The acousto-optical device of Aspect 18, wherein the first dummy finger and the second dummy finger comprise a non-conductive dielectric material.

Aspect 20. The acousto-optical device of Aspect 19, further comprising: a Bragg mirror, wherein the epitaxial AlScN piezoelectric layer is positioned on a top surface of the Bragg mirror; and a silicon substrate, wherein a bottom surface of the Bragg mirror is positioned on the silicon substrate.

Aspect 21. The acousto-optical device of any of Aspects 1 to 20, wherein a pitch of the first interdigital transducer and a pitch of the second interdigital transducer is selected for targeted modulation via Brillouin scattering within the waveguide.

Aspect 22. The acousto-optical device of any of Aspects 1 to 21, wherein the first interdigital transducer and the second interdigital transducer are associated with a resonance frequency selected to generate a double stress node in the waveguide.

Aspect 23. The acousto-optical device of any of Aspects 1 to 22, wherein the first interdigital transducer and the second interdigital transducer are associated with a resonance frequency selected to generate a single stress node in the waveguide for inter-modal scattering.

Aspect 24. The acousto-optical device of any of Aspects 1 to 23, wherein acoustic resonance properties of the first interdigital transducer and the second interdigital transducer are selected to facilitate Brillouin scattering between optical modes of the waveguide.

Aspect 25. The acousto-optical device of any of Aspects 1 to 24, wherein acoustic resonance properties of the first interdigital transducer and the second interdigital transducer are selected to an optical wavelength shift within the waveguide by Brillouin scattering.

Aspect 26. The acousto-optical device of any of Aspects 1 to 25, wherein acoustic resonance properties of the first interdigital transducer and the second interdigital transducer are selected to facilitate an optical phase shift within the waveguide by Brillouin scattering.

Aspect 27. The acousto-optical device of any of Aspects 1 to 26, further comprising: a silicon substrate; and a Bragg mirror formed between the silicon substrate and the piezoelectric layer.

Aspect 28. The acousto-optical device of any of Aspects 7, 8, 13-16, 20, or 27, wherein the Bragg mirror comprises: a bottom layer low impedance (Z) material formed on the silicon substrate; alternating layers of high Z material and low Z material formed on the bottom layer low Z material; and a top layer low Z material, wherein the piezoelectric layer is formed on or above the top layer low Z material.

Aspect 29. The acousto-optical device of Aspect 28, wherein the low Z material is selected from silicon oxide (SiO2), fluorine doped silicon dioxide (SiOF), or silicon oxycarbide (SiOC).

Aspect 30. The acousto-optical device of Aspect 28, wherein the high Z material is selected from tungsten (W), hafnia (HfO2), hafnium nitride (HfN), or tantalum pentoxide (Ta2O5).

Aspect 31. The acousto-optical device of any of Aspects 1 to 30, further comprising: a silicon substrate; and a silicon oxide (SiO2) layer formed between the silicon substrate and the piezoelectric layer.

Aspect 32. An apparatus for forming a solidly mounted acousto-optic device, the apparatus comprising: means for fabricating a silicon handle wafer; means for forming a piezoelectric layer having a top surface and a bottom surface, wherein the piezoelectric layer comprises an epitaxial aluminum scandium nitride (AlScN) layer, and wherein the top surface of the piezoelectric layer is formed on a surface of the silicon handle wafer; means for forming a silicon waveguide out of the silicon handle wafer on the top surface of the piezoelectric layer; means for forming a first interdigital transducer on the top surface of the piezoelectric layer, wherein the first interdigital transducer is positioned on a first side of the silicon waveguide; and means for forming a second interdigital transducer on the top surface of the piezoelectric layer, wherein the second interdigital transducer is positioned on a second side of the silicon waveguide opposite the first side.

Aspect 33. The apparatus of Aspect 32, further comprising: means for forming a Bragg mirror having a top surface and a bottom surface, wherein the top surface is formed on the bottom surface of the piezoelectric layer.

Aspect 34. The apparatus of Aspect 33, further comprising: means for bonding a silicon device wafer to the bottom surface of the Bragg mirror.

Aspect 35. The apparatus of Aspect 34, wherein the Bragg mirror comprises alternating layers of high impedance material and low impedance material.

Aspect 36. The apparatus of any of Aspects 34 or 35, wherein the Bragg mirror comprises alternating layers of material selected from combinations of silicon oxide (SiO2) and tungsten (W), SiO2 and aluminum nitride (AlN), or SiO2 and hafnia (HfO2).

What is claimed is:

1. An acousto-optical device comprising:
a piezoelectric layer comprising a top surface and a bottom surface;
a waveguide on the top surface of the piezoelectric layer;
a first interdigital transducer disposed on the top surface of the piezoelectric layer, wherein the first interdigital transducer is positioned on a first side of the waveguide; and
a second interdigital transducer disposed on the top surface of the piezoelectric layer, wherein the second interdigital transducer is positioned on a second side of the waveguide opposite the first side.

2. The acousto-optical device of claim 1, wherein the piezoelectric layer comprises epitaxial aluminum scandium nitride (AlScN).

3. The acousto-optical device of claim 1, wherein the waveguide comprises silicon positioned on the piezoelectric layer by depositing the piezoelectric layer on a silicon handle wafer and forming the waveguide from the silicon handle wafer.

4. The acousto-optical device of claim 1, wherein the waveguide comprises silicon nitride (SiN).

5. The acousto-optical device of claim 1, further comprising:
a first dummy finger formed between the first interdigital transducer and the waveguide; and
a second dummy finger formed between the second interdigital transducer and the waveguide.

6. The acousto-optical device of claim 5, wherein the first dummy finger and the second dummy finger comprise a non-conductive dielectric material.

7. The acousto-optical device of claim 1, further comprising:
a Bragg mirror, wherein the piezoelectric layer is positioned on a top surface of the Bragg mirror; and
a silicon substrate, wherein a bottom surface of the Bragg mirror is positioned on the silicon substrate.

8. The acousto-optical device of claim 7, wherein the Bragg mirror comprises alternating layers of high impedance material and low impedance material comprising at least: a top low impedance layer positioned at the bottom surface of the piezoelectric layer, a bottom low impedance layer formed at an interface with the silicon substrate, and an intermediate high impedance layer between the top low impedance layer and the bottom low impedance layer.

9. The acousto-optical device of claim 1, wherein a pitch of the first interdigital transducer and a pitch of the second interdigital transducer is selected for targeted modulation via Brillouin scattering within the waveguide.

10. The acousto-optical device of claim 1, wherein the first interdigital transducer and the second interdigital transducer are associated with a resonance frequency selected to generate a double stress node in the waveguide.

11. The acousto-optical device of claim 1, wherein the first interdigital transducer and the second interdigital transducer are associated with a resonance frequency selected to generate a single stress node in the waveguide for inter-modal scattering.

12. The acousto-optical device of claim 1, wherein acoustic resonance properties of the first interdigital transducer and the second interdigital transducer are selected to facilitate an optical phase shift within the waveguide by Brillouin scattering.

13. The acousto-optical device of claim 1, further comprising:
a silicon substrate; and
a Bragg mirror formed between the silicon substrate and the piezoelectric layer.

14. The acousto-optical device of claim 1, further comprising:
a silicon substrate; and
a silicon oxide (SiO2) layer formed between the silicon substrate and the piezoelectric layer.

15. A solidly mounted acousto-optic device formed by a method comprising:
fabricating a silicon handle wafer;
forming a piezoelectric layer having a top surface and a bottom surface, wherein the piezoelectric layer comprises an epitaxial aluminum scandium nitride (AlScN) layer, and wherein the top surface of the piezoelectric layer is formed on a surface of the silicon handle wafer;
forming a silicon waveguide out of the silicon handle wafer on the top surface of the piezoelectric layer;
forming a first interdigital transducer on the top surface of the piezoelectric layer, wherein the first interdigital transducer is positioned on a first side of the silicon waveguide; and
forming a second interdigital transducer on the top surface of the piezoelectric layer, wherein the second interdigital transducer is positioned on a second side of the silicon waveguide opposite the first side.

16. The solidly mounted acousto-optic device of claim 15, wherein the method further comprises:
forming a Bragg mirror having a top surface and a bottom surface, wherein the top surface is formed on the bottom surface of the piezoelectric layer.

17. A solidly mounted acousto-optical device comprising:
an epitaxial aluminum scandium nitride (AlScN) piezoelectric layer comprising a top surface and a bottom surface;
a silicon (Si) waveguide on the top surface of the epitaxial AlScN piezoelectric layer;
a first interdigital transducer disposed on the top surface of the epitaxial AlScN piezoelectric layer, wherein the first interdigital transducer is positioned on a first side of the Si waveguide; and
a second interdigital transducer disposed on the top surface of the epitaxial AlScN piezoelectric layer, wherein the second interdigital transducer is positioned on a second side of the waveguide opposite the first side.

18. The acousto-optical device of claim 17, further comprising:
a first dummy finger formed between the first interdigital transducer and the Si waveguide; and
a second dummy finger formed between the second interdigital transducer and the Si waveguide.

19. The acousto-optical device of claim 18, wherein the first dummy finger and the second dummy finger comprise a non-conductive dielectric material.

20. The acousto-optical device of claim 19, further comprising:
a Bragg mirror, wherein the epitaxial AlScN piezoelectric layer is positioned on a top surface of the Bragg mirror; and
a silicon substrate, wherein a bottom surface of the Bragg mirror is positioned on the silicon substrate.
